(19) United States
(12) Patent Application Publication
(10) Pub. No.: US 2011/0244353 A1
(43) Pub. Date: Oct. 6, 2011

(54) METHOD OF OBTAINING OPTIMAL DESIGN FOR A HEADER OF FUEL CELL STACK AND FUEL CELL STACK WITH AN OPTIMALLY DESIGNED HEADER

(75) Inventors: Po-Hsein Chou, Kwei Shan Township (TW); Chi-Bin Wu, Kwei Shan Township (TW)

(73) Assignee: Chung-Hsin Electric and Machinery Manufacturing Corp., Jhonghe City (TW)

(21) Appl. No.: 12/787,550

(22) Filed: May 26, 2010

(30) Foreign Application Priority Data
Apr. 2, 2010 (TW) 099110459

(51) Int. Cl. H01M 8/24; H01M 8/00

(52) U.S. Cl. 429/456; 429/535

(57) ABSTRACT

A method of obtaining an optimal design for a header of a fuel cell stack and a fuel cell stack with an optimally designed header are provided. The method includes providing a fuel cell stack and obtaining an optimal design for a header of the fuel cell stack. The fuel cell stack is composed by stacking multiple fuel cell units such that header openings thereof are connected to form a header. A control unit is inserted in one side of each header opening to individually control the widths of the header openings and consequently the flow rate of fuel gas passing therethrough. Thus, fuel gas distribution in the fuel cell stack is rendered uniform, and the efficiency of electric power generation by the fuel cell stack is improved. The header openings with the ideal widths define a curvilinear structure which constitutes the optimal design for the header.

### BACKGROUND OF THE INVENTION

1. Technical Field

The present invention relates to the structural design of fuel cell stacks and, more particularly, to a method of obtaining an optimal design for a header of a fuel cell stack and a fuel cell stack with an optimally designed header.

2. Description of Related Art

Fuel cells generate electric power by a series of electrochemical reactions which involve hydrogen and oxygen as reactants. As the products of such electrochemical reactions are no more than electricity, waste heat, and water, fuel cells are relatively environment-friendly power generation devices. Furthermore, as the voltage and current generated by a single fuel cell unit is too low to be used alone, it is common practice nowadays to form a fuel cell stack by stacking and connecting a plurality of fuel cell units. The resultant fuel cell stack is a compact structure suitable for product design.

FIG. 1 shows a flow field plate 11 of a conventional fuel cell stack. FIG. 2A and FIG. 2B are schematic drawings showing a conventional fuel cell stack 100 with a U-shaped header and a conventional fuel cell stack 100 with a Z-shaped header, respectively.

As shown in FIG. 1, the flow field plate 11 is configured for guiding fuel gas, such as hydrogen and oxygen, into a fuel cell unit for electrochemical reactions. The flow field plate 11 is peripherally provided with header openings 12a, 12b through which fuel gas enters and exits the fuel cell unit. The flow field plate 11 is also formed with channels 13 which open into the header openings 12a, 12b. Thus, fuel gas enters the fuel cell unit via the header openings 12a and is guided by the channels 13 so as to be distributed in the fuel cell unit. The byproducts of the electrochemical reactions are also guided by the channels 13 and then discharged through the header openings 12b.

Referring to FIGS. 2A and 2B, the fuel cell stacks 100 are each composed of a plurality of fuel cell units 10 stacked together such that the header openings 12 of the fuel cell units 10 are connected to form a header 14. The header 14 can be further divided into an admission header 141 and a discharge header 142. As is well known in the art, the header 14 can also be categorized by configuration into a U-shaped header (as shown in FIG. 2A) and a Z-shaped header (as shown in FIG. 2B).

However, regardless of the types of the header 14, it is always difficult to distribute fuel gas uniformly into each fuel cell unit 10. First of all, with the header 14 having a fixed width, the channels 13 in the fuel cell stack 100 that are at the opposite ends of the header 14 tend to have the lowest flow rate while the channels 13 in the middle have the highest flow rate. As a result, none of the fuel cell units 10 generates electric power at optimal efficiency. Secondly, each fuel cell unit 10 has its own power generation condition that is hard to control, and many of the variable factors cannot be determined by simulation. Therefore, if the efficiency of electric power generation by each fuel cell unit 10 can be raised, the overall efficiency of the fuel cell stack 100 will be enhanced as well.

### BRIEF SUMMARY OF THE INVENTION

It is an object of the present invention to provide a method of obtaining an optimal design for a header of a fuel cell stack and a fuel cell stack with an optimally designed header, wherein control units are adjusted in position to control the widths of header openings, thereby allowing each fuel cell unit to generate electric power at optimal efficiency.

It is another object of the present invention to provide a method of obtaining an optimal design for a header of a fuel cell stack and a fuel cell stack with an optimally designed header, wherein the optimal design for the header of the fuel cell stack is obtained by controlling the widths of header openings with control units. The optimal design for the header enables the fuel cell stack to reach the optimal output voltage value.

To achieve the foregoing objects, the present invention provides a method of obtaining an optimal design for a header of a fuel cell stack. The method includes the steps of providing a fuel cell stack and obtaining an optimal design for a header. The fuel cell stack is provided by stacking a plurality of fuel cell units, wherein each fuel cell unit has at least one header opening. The header openings are connected to form a header after the fuel cell units are stacked together. In addition, a control unit is provided on a side of each header opening. The optimal design for the header is obtained by adjusting each control unit and thus controlling the widths of the header openings individually so as for the output voltage of each fuel cell unit to reach an optimal value. After the adjustment, the control units define a curvilinear structure which constitutes the optimal design for the header.

To achieve the foregoing objects, the present invention also provides a fuel cell stack with uniform fuel gas distribution. The fuel cell stack includes a plurality of fuel cell units, and each fuel cell unit has at least one header opening. After the fuel cell units are stacked together, the header openings are connected to form a header. The fuel cell stack is characterized in that the header has a designed curvilinear structure and that the output voltage value of each fuel cell unit is optimized.

Implementation of the present invention at least involves the following inventive steps:

1. By adjusting the control units, the electric power generation efficiency of each fuel cell unit is optimized.

2. By constructing the header of the fuel cell stack as a designed curvilinear structure, the output voltage of the fuel cell stack is optimized.

### BRIEF DESCRIPTION OF THE SEVERAL VIEWS OF THE DRAWINGS

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings, in which:

FIG. 1 shows a flow field plate of a conventional fuel cell stack;

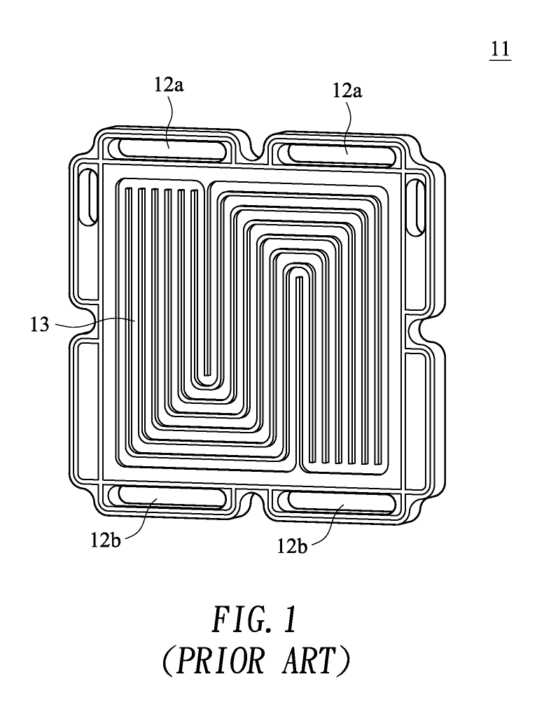

FIG. 2A is a schematic drawing of a conventional fuel cell stack with a U-shaped header;

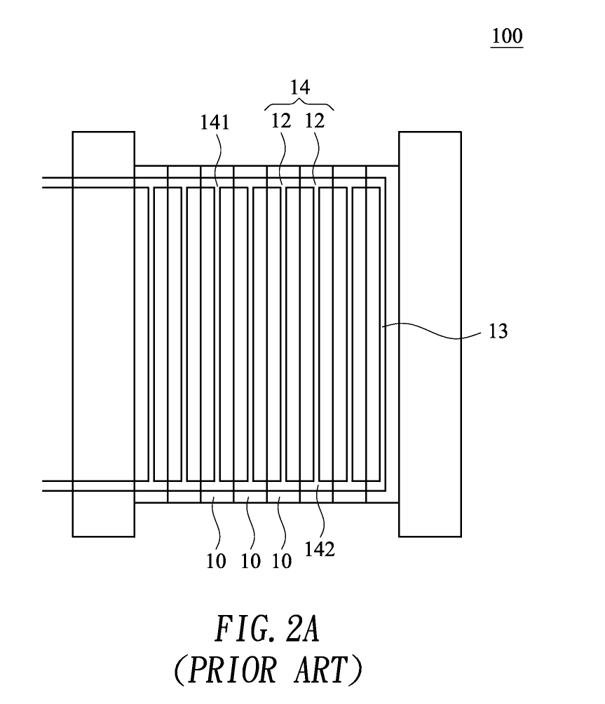

FIG. 2B is a schematic drawing of a conventional fuel cell stack with a Z-shaped header;

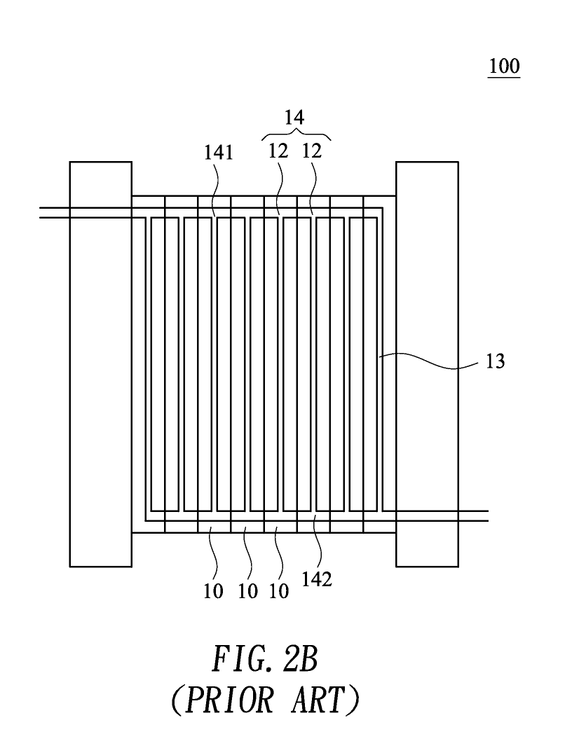

FIG. 3 is a flowchart of a method of obtaining an optimal design for a header of a fuel cell stack according to the present invention;

FIG. 4 is a perspective view of a fuel cell stack with uniform fuel gas distribution according to the present invention;

FIG. 5 is a transverse sectional view taken along line A-A of FIG. 4;

FIG. 6 is a longitudinal sectional view taken along line B-B of FIG. 4; and

FIG. 7 is another sectional view of the fuel cell stack with uniform fuel gas distribution according to the present invention.

### DETAILED DESCRIPTION OF THE INVENTION

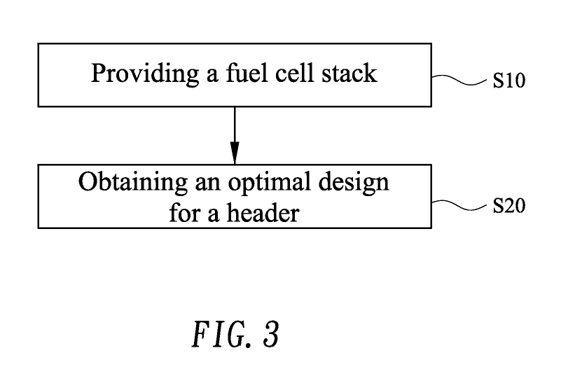

Referring to FIG. 3, a method of obtaining an optimal design for a header of a fuel cell stack includes the steps of: providing a fuel cell stack (S10) and obtaining an optimal design for a header (S20).

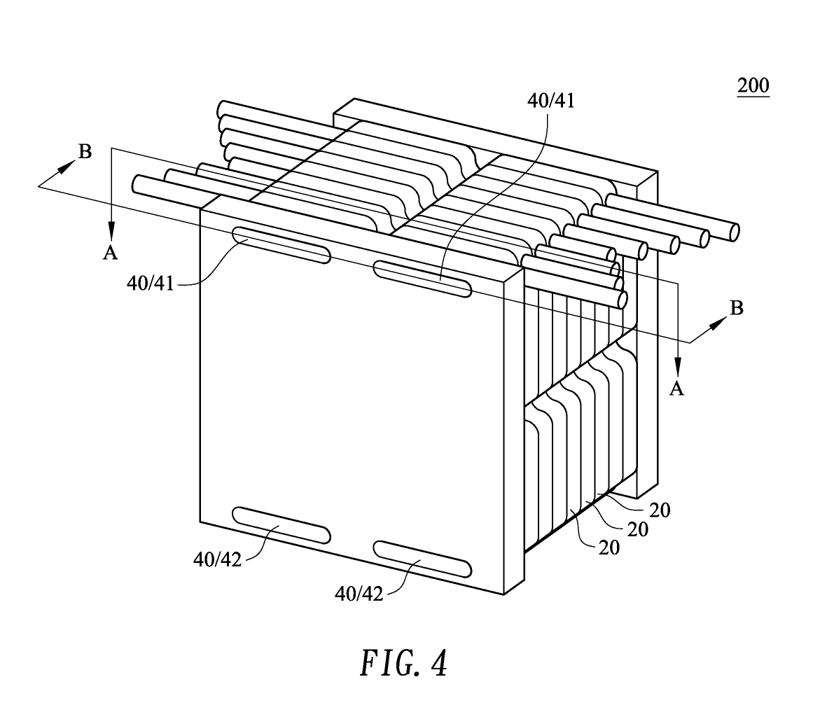

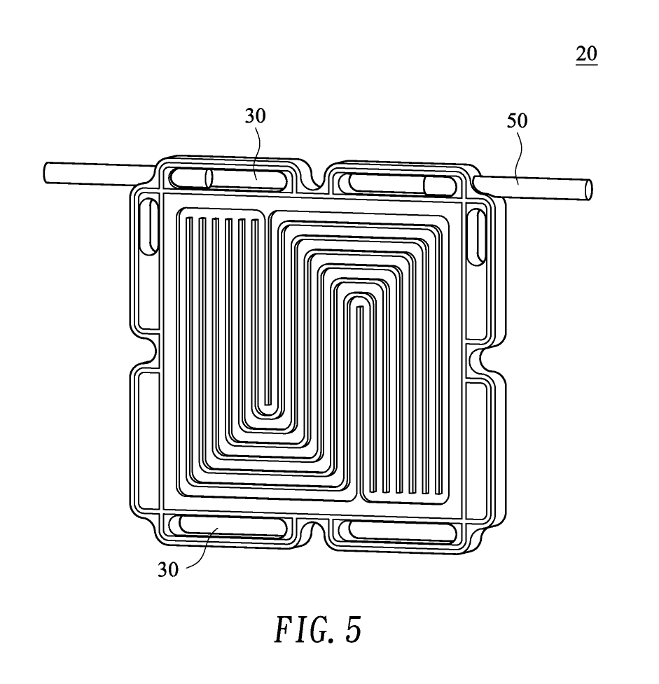

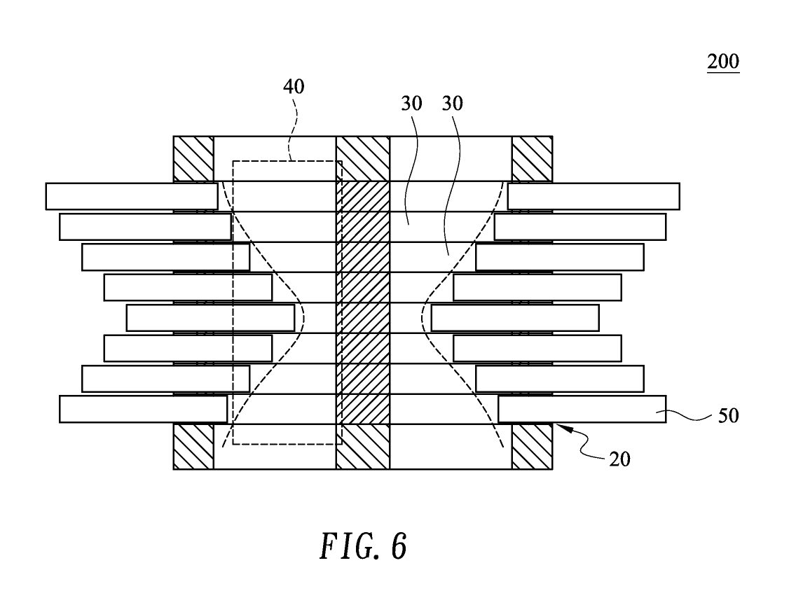

The step of providing a fuel cell stack (S10) is described hereinafter by reference to FIGS. 4 to 6. As shown in the drawings, a fuel cell stack 200 is composed by stacking a plurality of fuel cell units 20, wherein each fuel cell unit 20 has at least one head opening 30 (as shown more clearly in FIGS. 5 and 6). After the fuel cell units 20 are stacked together, the header openings 30 are connected to form a header 40 (as shown more clearly in FIG. 4). The header 40 can be divided by function into admission headers 41 and discharge headers 42. In the present embodiment, a control unit 50 is provided on one side of each header opening 30 of each fuel cell unit 20. The positions of the control units 50 are adjusted to change the depths to which the control units 50 are inserted in the header openings 30 and thereby control the widths of the header openings 30. Thus, the flow rate of fuel gas passing through each fuel cell unit 20 is individually controlled by the corresponding control unit 50.

As shown in FIGS. 4 to 6, the control units 50 can be screws, bolts, cylinders, or baffle plates. More specifically, the control units 50 can be any objects capable of obstructing the header openings 30. In the present embodiment, wherein cylinders are used as the control units 50, a cylinder is disposed on one side of each header opening 30 located at the fuel gas admission end. Moreover, the areas where the control units 50 contact with the header openings 30 are rendered airtight to prevent the fuel gas in the header openings 30 from leaking. As the control units 50 are partially located in the header openings 30 and partially exposed from the fuel cell units 20, the control units 50 can be adjusted from outside. In addition, while not shown in the present embodiment, the control units 50 may also be provided respectively on one side of the header openings 30 situated at the fuel gas discharge end.

The step of obtaining an optimal design for a header (S20) is carried out in the following manner. In order to obtain the optimal design for the header 40, the position of each control unit 50 inside the corresponding header opening 30 can be adjusted, so as to control the widths of the header openings 30 individually. This is because the widths of the header openings 30 are the main factor that influences the flow rate of fuel gas. Thus, the flow rates of fuel gas in the fuel cell units 20 are individually adjusted to allow the output voltage of each fuel cell unit 20 to reach the optimal value. After the widths of the header openings 30 that form the header 40 are adjusted one by one by the control units 50, and the output voltage of each fuel cell unit 20 is optimized, the control units 50 define a curvilinear structure that constitutes the optimal design of the header 40 (as shown in FIG. 6).

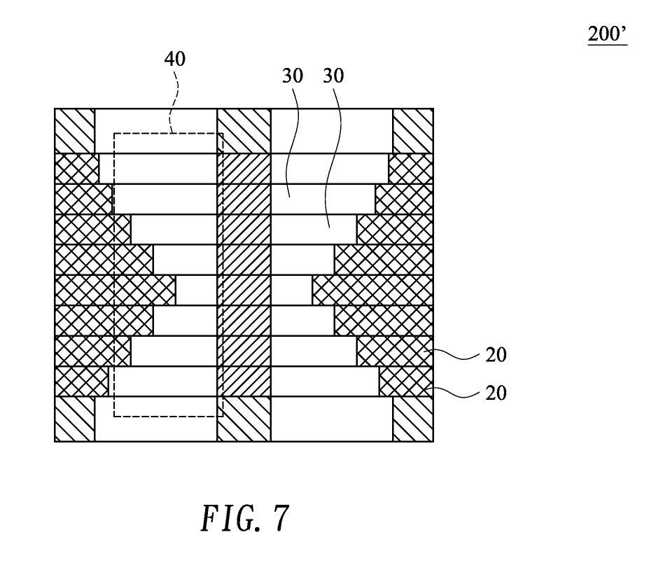

With reference to FIG. 7, a fuel cell stack 200′ made according to the optimal design for the header 40 and featuring uniform fuel gas distribution includes a plurality of fuel cell units 20, wherein each fuel cell unit 20 has at least one header opening 30. After the fuel cell units 20 are stacked up, the header openings 30 are connected to form a header 40. The fuel cell stack 200′ is characterized in that the header 40 has a designed curvilinear structure and that the output voltage of each fuel cell unit 20 is optimized.

In short, the control units 50 are adjusted by monitoring the optimal power generation efficiency of each fuel cell unit 20, and the final relative positions of the control units 50 define a curvilinear structure that constitutes the optimally designed header 40. In a preferred embodiment of the present invention, the control units 50 are disposed at the fuel gas admission end of the header 40. Besides, the method of obtaining the optimal design for the header 40 of the fuel cell stack 200 is applicable to a fuel cell stack 200 in the test phase so that, after the overall power generation efficiency of the fuel cell stack 200′ is optimized, product design can be carried out based on the optimal design for the header 40, thereby reducing the development costs of the fuel cell stack 200. The method of the present embodiment is further applicable to any fuel cell stacks 200 having header openings 30.

The embodiments described above serve to demonstrate the features of the present invention so that a person skilled in the art can understand the contents disclosed herein and implement the present invention accordingly. The embodiments, however, are not intended to limit the scope of the present invention, which is defined only by the appended claims. Therefore, all equivalent changes or modifications which do not depart from the spirit of the present invention should fall within the scope of the appended claims.

What is claimed is:

1. A method of obtaining an optimal design for a header of a fuel cell stack, comprising steps of:
providing a fuel cell stack composed by stacking a plurality of fuel cell units, each said fuel cell unit having at least one header opening, the header openings connected to form a header after the fuel cell units are stacked together, wherein a control unit is provided on a side of each said header opening; and
obtaining an optimal design for the header by adjusting each said control unit so as to individually control widths of the header openings and allow output voltage of each said fuel cell unit to reach an optimal value, wherein the control units, after being adjusted, define a curvilinear structure which constitutes the optimal design for the header.

2. The method of claim 1, wherein the header is an admission header.

3. The method of claim 1, wherein the header is a discharge header.

4. The method of claim 1, wherein the control units are screws, bolts, cylinders, or baffle plates.

5. The method of claim 1, wherein the control units are further adjusted from outside.

6. A fuel cell stack with uniform fuel gas distribution, wherein the fuel cell stack comprises a plurality of fuel cell units, each said fuel cell unit having at least one header opening, the header openings connected to form a header after the fuel cell units are stacked together, the fuel cell stack characterized in that the header has a designed curvilinear structure and that output voltage of each said fuel cell unit reaches an optimal value.
